(19) United States
(12) Patent Application Publication
(10) Pub. No.: US 2026/0366823 A1
(43) Pub. Date: Nov. 19, 2026

(54) DEVICE FOR TRANSFERRING THERMAL ENERGY INTO A FLUID

(71) Applicant: EMITEC TECHNOLOGIES GMBH, Lohmar (DE)

(72) Inventor: Johannes MEENEN, Lohmar (DE)

(21) Appl. No.: 19/142,431

(22) PCT Filed: Nov. 30, 2023
(86) PCT No.: PCT/EP2023/083662

§ 371 Date: Jun. 23, 2025

(30) Foreign Application Priority Data
Dec. 22, 2022 (DE) 10 2022 214 347.7

(51) Int. Cl. F28D 17/02; F28D 9/04; F28D 20/00; F28F 21/06

(52) U.S. Cl. CPC F28D 17/02; F28D 9/04; F28D 20/0056; F28F 21/06

(57) ABSTRACT

A device transfers thermal energy into a fluid. The device has a heat exchanger which is located in a flow path spatially delimited by a housing. The heat exchanger has a plurality of flow channels through which a flow can pass along a main flow direction. The heat exchanger has a heat storage capacity which can temporarily store thermal energy, a relatively high-energy fluid and a relatively low-energy fluid alternately flowing through the heat exchanger.

The invention relates to a device for transferring heat energy into a fluid or onto a fluid (heat regenerator), with a heat exchanger which is arranged in a flow path spatially limited by a housing. The heat exchanger has a plurality of flow channels through which flow can pass along a main flow direction. The heat exchanger has a heat storage capacity, through which a defined amount of heat energy can be temporarily stored.

The invention also relates to a method for using the device.

In addition to conventional heat exchangers (recuperators), regenerators can also be used for the exchange of heat between two fluids or for the recovery of heat. They essentially consist of a porous heat storage medium or one provided with channels. During a heating phase, the heat storage device is flowed through and heated by a first or warm fluid. The (first) fluid cools down in the process. During a cooling phase, it releases the stored heat to a second or cold fluid.

This technology is used, for example, in the ventilation of buildings or enclosed rooms in general. So-called push-pull heat exchangers, such as those used for ventilating buildings, consist of a piping in which a ceramic material with channels is used as a heat storage medium and a fan that can be switched in the conveying direction. The unit is installed in the outer wall of the building and alternately conveys warm indoor air (exhaust air) to the outside and, after switching the conveying direction, cold outdoor air (fresh air) to the inside. This uses the heat from the exhaust air to preheat the fresh air.

To ensure high efficiency in heat recovery, good heat transfer between the heat accumulator and the fluid must be ensured. The size of the surface available for heat exchange and the heat transfer coefficient of the flow in the heat exchanger are decisive factors here. The duration of the periods during which the heat exchanger is heated or cooled must be adapted to the heat capacity of the heat storage device in order to prevent, for example, further exhaust air, especially warm exhaust air, from being conveyed past the heat storage device when the maximum heat capacity is reached.

The heat accumulators known in the prior art for such heat exchangers are usually made of a ceramic material. This is disadvantageous because, for example, the manufacturing costs are high. Furthermore, ceramics have properties that are not necessary for use in a ventilation system for buildings or vehicles, such as the resistance of ceramics to high temperatures and aggressive media. In addition, the design options for the channel shape are very limited, which has a negative impact on the amount of heat transfer between the fluid and the matrix, the possible efficiency, and the operating range of the heat exchanger. It is also disadvantageous that air humidity is adsorbed and desorbed in porous ceramics. This occurs in particular at and around the dew point.

For the purpose of heating or air conditioning the interior of a battery-electric vehicle, the required energy must be drawn from the vehicle battery. This reduces the range of the vehicle at high or low outside temperatures. Heat exchangers, such as regenerators, can also be used here to keep the energy requirement to a minimum and thus increase the range.

Therefore, the object of the present invention is to provide a device which at least partially solves the problems described with reference to the prior art and, in particular, enables heat energy to be transferred between fluids, in particular heat energy from a fluid of a higher energy level to a fluid of a lower energy level.

The objects are achieved by the features of the independent claims. Advantageous Further developments are indicated in the dependent claims. The features listed individually in the claims can be combined with each other and/or with features of the description in any manner. The description, in particular in connection with the figures, explains the invention and indicates additional embodiments.

A device is proposed for transferring heat energy into a fluid or for transferring heat energy onto a fluid, comprising a heat exchanger which is arranged in a flow path spatially limited by a housing, wherein the heat exchanger has a plurality of flow channels through which flow can pass along a main flow direction, wherein the heat exchanger has a heat storage capacity by means of which a defined amount of heat energy can be temporarily stored, wherein the heat exchanger is alternately flowed through or is capable of being flowed through by a fluid with relatively higher energy and a fluid with relatively lower energy.

The quantity and/or time of the temporarily storable heat energy can be specified or defined with reference to the operation of the device. In particular, means can be provided by which the temporal and/or volumetric flows through the device can be predetermined, so that the required heat storage capacity of the heat exchanger can also be predetermined or defined.

A device can be used, for example, for ventilating and/or temperature-regulating a building or for ventilating and/or temperature-regulating the interior of a motor vehicle. The flow path can be formed by a pipe or, for example, by the air ducts of a motor vehicle. The heat exchanger is arranged in the flow path in such a way that it can be flowed through or is flowable by a fluid, in particular air. When a first and/or warm air flows through the heat exchanger, heat or heat energy can be absorbed by the heat exchanger and at least temporarily stored. When a second and/or cold air flows through the heat exchanger, it can absorb the heat or heat energy temporarily stored in the heat exchanger. In the same way, other energies contained in the fluid, such as the evaporation enthalpy of the air humidity, can be temporarily stored as heat or heat energy in the heat exchanger.

This allows heat or heat energy to be absorbed from indoor air, especially stale air, and transferred to the fresh air supplied from outside. The energy loss during air exchange can thus be reduced.

The heat exchanger is preferably flowed through in the opposite direction when the heat or heat energy is released and when the heat or heat energy is absorbed, thereby improving the heat transfer to the air. The heat exchanger is preferably designed to allow heat or heat energy to flow in opposite directions, thereby improving heat transfer to the air.

Depending on the sequence of the heat transfer steps, the fresh air supplied from outside can be heated or cooled. In addition to heat transfer between the outside air and the inside air, an air flow can also be passed through or past heated components, such as the power electronics and/or the battery of a motor vehicle, for example, so that the waste heat generated there can be used to heat fresh air for the interior.

The fluid flowable through the heat exchanger has a respective temperature level. The fluid may have a higher energy level and thus be warmer, or it may have a lower energy level and thus be colder. The heat or thermal energy is transferred from the fluid to the heat exchanger as it flows through, and is then transferred back from the heat exchanger to the fluid when a fluid with a lower energy level flows through the heat exchanger.

The flow path may have a conveying device or be fluidically connected to a conveying device through which the fluid can be conveyed through the flow path. A suitable conveying device may be, for example, a fan arranged in the flow path. Alternatively, the fan of a vehicle air conditioning or vehicle ventilation system can also be used to direct a fluid flow, in particular a targeted fluid flow, through the heat exchanger.

It is possible that the heat exchanger is formed (at least partially) from a plurality of foils, wherein the foils are at least partially structured and the foils are stacked on top of each other to form a layer stack. A preferred embodiment is characterized in that the foils stacked on top of one another to form a layer stack are wound and/or twisted, in particular around at least one axis of rotation.

In this way, a matrix can be produced which has a large surface area that can be wetted by the fluid and which has a plurality of flow channels between the individual foils through which fluid can flow. The foils then also serve as heat accumulators, which absorb the heat or heat energy of a first and/or warm fluid and finally release the heat or heat energy to a second and/or cold fluid when it flows through.

The foils can be made of metal or plastic. Metal foils or plastic foils can be produced easily and particularly cost-effectively. The material properties can be adapted particularly easily to the respective area of application, which enables the precise manufacture of a heat exchanger for a specific purpose.

It is possible that at least one of the foils is electrically conductive and is electrically connected to a voltage source. An electrically conductive foil can be used to achieve additional heating from a fluid flowing past. The foil can be connected to a voltage source and heated or be heatable using ohmic resistance. The electrical insulation of the current-carrying foils from the adjacent foils can be achieved by means of adjacent, electrically non-conductive foils. These can, for example, be made of a non-electrically conductive material or be coated with a non-conductive coating.

The heat exchanger can be made of a composite material, wherein a material with relatively higher thermal conductivity is used and a material with relatively lower thermal conductivity is used.

This serves in particular to reduce heat conduction within the carrier material, which can reduce the efficiency of the regenerator. Preferably, the material with the higher thermal conductivity is interrupted at short intervals in the direction of flow, whereby good efficiency can be achieved even when using materials with high thermal conductivity.

It may also be useful if the material with the relatively higher thermal conductivity is interrupted into several sections along the main flow direction. This can be achieved, for example, by means of foils having slots. The main flow direction may extend, in particular, at least partially parallel to a longitudinal axis of the device, the heat exchanger and/or the housing.

The structured part of the foils may have cross-section-narrowing or turbulence-generating structures, by means of which a throttling of the fluid flow in the flow direction can be produced. This allows the flow to be throttled in a targeted manner. The throttling can be used to improve the heat exchange between the flowing fluid and the channel wall or to cause a phase change of the fluid. The turbulence-generating structures can be designed asymmetrically so that they are effective to different degrees in the two flow directions. A heat exchanger with an integrated throttle offers particular advantages in the design of refrigeration machines, as the heat exchanger can also perform the function of the throttle.

It is possible for the heat exchanger and the throttle to be formed in a common component. This reduces the number of components required and can significantly simplify a system or device. This is particularly advantageous for use in refrigeration systems.

According to a further aspect, a method for heating or cooling a room using a device (described here) is proposed, wherein the heat exchanger is flowed through by a fluid, in particular a first fluid, at a higher temperature, wherein the heat energy of the fluid (at a higher temperature) is transferred to the heat exchanger, whereupon the heat exchanger is flowed through by a fluid, in particular a second fluid, at a lower temperature, wherein the heat energy stored in the heat exchanger is transferred to the fluid (at a lower temperature). This reduces the energy required for heating or air conditioning, thereby increasing the range of battery-electric vehicles.

The device proposed here is intended in particular to improve the range of battery-electrically-powered vehicles, as less energy from the batteries is required for ventilation, cooling, or heating the interior. By using the waste heat from the vehicle drive components, such as the battery, the power electronics, and the electric drive motor, the energy requirement can be further reduced, which also has a positive effect on the range.

The technical details and/or modes of operation specified in relation to the device can also be used to characterize the method, and vice versa. In particular, the device can be set up to carry out the method, or the method can be carried out using a device proposed here.

The invention and the technical environment are explained in more detail below with reference to the figures. It should be noted that the figures show a particularly preferred embodiment of the invention, but that the invention is not limited to this embodiment. Identical components are designated by the same reference signs in the figures. The following figures show examples and schematics:

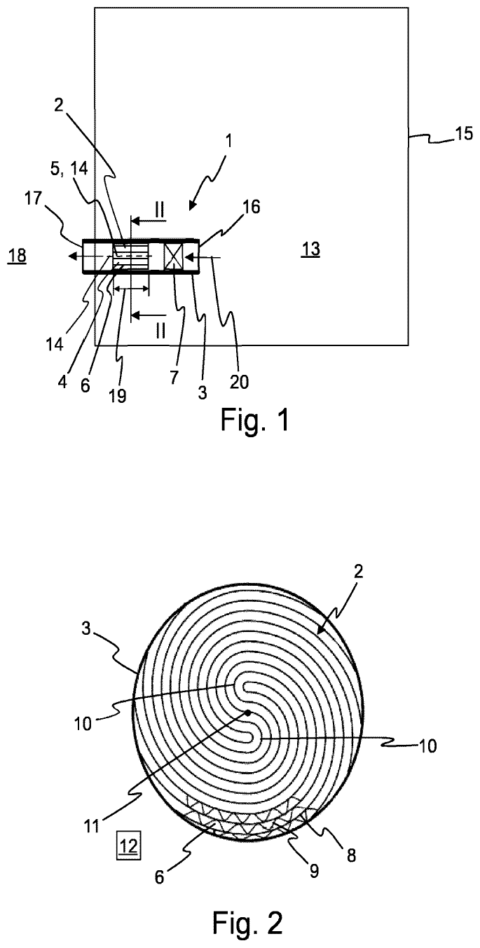

FIG. 1: a building with a device for transferring heat energy; and

FIG. 2: a heat exchanger of the device in cross-section.

FIG. 1 shows a building 15 in which a device 1 for transferring heat energy is arranged. The device 1 comprises a flow path 4 with a first opening 16 and a second opening 17. The first opening 16 is located inside the building 15 and the second opening 17 outside the building 15. The flow path 4 extends from a room 13 of the building 15 to an exterior area 18 of the building 2. A conveying device 7 and a heat exchanger 2 are arranged in the flow path 4. The heat exchanger 2 extends along a longitudinal axis 14 and has a plurality of flow channels 6. The flow channels 6 extend parallel to the longitudinal axis 14 or to a main flow direction 5. The heat exchanger 2 extends along the longitudinal axis 14 with a length 19.

By means of the conveying device 7, an air flow 20 can be generated in the flow path 4. The conveying device 7 can be operated in such a way that used air enters the flow path 4 from the room 13 of the building 15 via the first opening 16, flows through the heat exchanger 2 and flows out of the flow path 4 into the exterior area 18 via the second opening 17. In this case, the first opening 16 serves as an air inlet and the second opening 17 as an air outlet. When the used air flows through the flow path 4 from the first opening 16 to the second opening 17, the heat exchanger 2 can temporarily store thermal energy from the air flow or the used air.

The conveying device 7 can then be operated in such a way that fresh air enters the flow path 4 from the exterior area 18 via the second opening 17, flows through the heat exchanger 2 and flows out of the flow path 4 into the room 13 of the building 15 via the first opening 16. In this case, the second opening 17 serves as an air inlet and the first opening 16 as an air outlet. When the fresh air flows through the flow path 4 from the second opening 17 to the first opening 16, the heat exchanger 2 can transfer the temporarily stored thermal energy to the air flow or the fresh air. This preheats the fresh air flowing into the building 15.

FIG. 2 shows the heat exchanger 2 in a cross-section along the section line II-II shown in FIG. 1. The heat exchanger 2 is arranged in a housing 3. The heat exchanger 2 comprises a plurality of structured foils 9 and smooth foils 8. The structured foils 9 and the smooth foils 8 are stacked alternately on top of each other to form two layer stacks 10, and the layer stacks 10 are wound around an axis of rotation 11 to the heat exchanger 2 so that the foils 8, 9 form the plurality of flow channels 6. At least one of the foils 8, 9 is electrically conductive and connected to a voltage source 12 (electrically conductive).

### LIST OF REFERENCE SIGNS

1 device
2 heat exchanger
3 housing
4 flow path
5 main flow direction
6 flow channel
7 conveying device
8 smooth foil
9 structured foil
10 layer stack
11 axis of rotation
12 voltage source
13 room
14 longitudinal axis
15 building
16 first opening
17 second opening
18 exterior area
19 length
20 air flow

1-10. (canceled)

11. A device for transferring heat energy into a fluid, the device comprising:
a housing spatially limiting a flow path; and
a heat exchanger disposed the flow path, wherein said heat exchanger has a plurality of flow channels through which a fluid flow can pass along a main flow direction, wherein said heat exchanger has a heat storage capacity by means of which heat energy can be temporarily stored, and wherein said heat exchanger is alternately flowed through by a fluid with relatively higher energy and a fluid with relatively lower energy.

12. The device according to claim 11, further comprising a conveying device, the flow path has said conveying device or is fluidically connected to said conveying device and through said conveying device the fluid is conveyable through the flow path.

13. The device according to claim 11, wherein said heat exchanger is formed from a plurality of foils, wherein some of said foils are at least partially structured and said foils are stacked on top of one another to form a layer stack.

14. The device according to claim 13, wherein said foils stacked on top of one another to form the layer stack are wound or twisted around at least one axis of rotation.

15. The device according to claim 13, wherein said foils are made of metal or plastic.

16. The device according to claim 13, wherein at least one of said foils is electrically conductive and is configured for electrically conductively connecting to a voltage source.

17. The device according to claim 11, wherein said heat exchanger is made of a composite material, said composite material includes a first material with a relatively higher thermal conductivity and a second material with a relatively lower thermal conductivity.

18. The device according to claim 17, wherein said first material with the relatively higher thermal conductivity is interrupted into several sections along the main flow direction.

19. The device according to claim 13, wherein a structured part of said foils has a cross-section-narrowing or turbulence-generating structures, by means of said structured part a throttling of the fluid flow in the main flow direction can be produced.

20. A method for heating, cooling or ventilating a room, which comprises
providing the device according to claim 11; and
flowing through the heat exchanger the fluid at a higher temperature, wherein heat energy of the fluid is transferred to the heat exchanger, where upon the heat exchanger is flowed through by a fluid at a lower temperature being lower than the fluid of the higher temperature, wherein heat energy stored in the heat exchanger is transferred to the fluid at the lower temperature.
